(19) United States
(12) Patent Application Publication
(10) Pub. No.: US 2023/0142526 A1
(43) Pub. Date: May 11, 2023

(54) SYSTEMS AND METHODS OF PREDICTIVE DECLINE MODELING FOR A WELL

(71) Applicant: ConocoPhillips Company, Houston, TX (US)

(72) Inventors: Qing Chen, Houston, TX (US); Xin Luo, Houston, TX (US); Amir Nejad, Houston, TX (US); Bo Hu, Houston, TX (US); Christopher S. Olsen, Houston, TX (US); Alexander J. Wagner, Houston, TX (US); Iman Shahim, Houston, TX (US); Curt E. Schneider, Houston, TX (US); David D. Smith, Houston, TX (US); Andy Flowers, Houston, TX (US); Liu Chao Zhang, Houston, TX (US)

(21) Appl. No.: 17/982,926

(22) Filed: Nov. 8, 2022

Related U.S. Application Data
(60) Provisional application No. 63/276,838, filed on Nov. 8, 2021.

(51) Int. Cl. G06F 30/28

(52) U.S. Cl. CPC G06F 30/28

(57) ABSTRACT

Systems and method for predicting production decline for a target well include generating a static model and a decline model to generate a well production profile. The static model is generated with supervised machine learning using an input data set including historical production data, and calculates an initial resource production rate for the target well. The decline model is generated with a neural network using the input data and dynamic data (e.g., an input time interval and pressure data of the target well), and calculates a plurality of resource production rates for a plurality of time intervals. The system can perform multiple recursive calculations to calculate the plurality of resource production rates, generating the well production profile. For instance, the predicted resource production rate of a first time interval is used as one of inputs for predicting the resource production rate for a second, subsequent time interval.

### CROSS-REFERENCE TO RELATED APPLICATIONS

The present application claims priority to U.S. Provisional Patent Application No. 63/276,838 filed on Nov. 8, 2021, which is incorporated by reference in its entirety herein.

### TECHNICAL FIELD

Aspects of the present disclosure relate generally to systems and methods for modeling well production and more particularly to predicting well production decline for a target well by utilizing a trained machine learning system and a trained neural network system.

### BACKGROUND

Effective and accurate prediction of well production is used for business decisions during field development and operation. Well production behavior depends on many factors, including the recovery mechanisms driving fluids to the production wells, reservoir characteristics, well completion parameters, and operation constraints. The complex nature of the fluid flow and transport within the reservoir makes it challenging to accurately predict the flow streams of a given well in a reservoir. Traditional approaches have been developed with assumptions of simplified physics to model well production behaviors. Those physics-based modeling methods, however, suffer from the high cost of computation and may include invalid underlying assumptions when dealing with highly complicated reservoir systems and complex recovery mechanisms. Moreover, typical systems may compound error rates as the predictions extend further into the future. As such, typical systems often yield inaccurate, inefficient prediction with limited forecasting abilities.

It is with these observations in mind, among others, that various aspects of the present disclosure were conceived and developed.

### SUMMARY

Implementations described and claimed herein address the foregoing problems by providing systems and methods for modeling production decline for a well by generating a well production profile. For instance, a method of predictive decline modeling for an oil well comprises: generating a static model based on an input data set including historical production data corresponding to one or more wells; generating a decline model based on the historical production data and dynamic well data; and generating a predicted well production profile for a target well by: calculating, using the static model and one or more well features of the target well, a predicted initial resource production rate for the target well; calculating, using the decline model and the predicted initial resource production rate, a first final resource production rate for the target well at a first time interval; and calculating, using the decline model and the first final resource production rate at the first time interval, a second final resource production rate at a second time interval subsequent to the first time interval.

In some examples, generating the predicted well production profile includes recursive calculations generating resource production rates for a series of time intervals. The static model can be generated with supervised machine learning using the historical production data as feature inputs and a target variable being an initial resource production rate having a 30 days-averaged Initial Production (IP30) value. The historical production data can represent one or more of a geological feature, well completion parameters, reservoir properties, production data, injection data, and fluid data. Moreover, in some instances, the decline model is generated with a neural network using the historical production data and the dynamic well data as feature inputs and a target variable being resource production rate at time (t). The neural network can include two to seven dense layers and between 100 and 600 neurons per layer. Additionally, the dynamic well data can include one or more of a resource production rate for a previous time interval, a bottom hole pressure at the target well, a shut-in bottom hole pressure at the target well, and an average draw down pressure at the target well.

In some examples, the method further comprises: identifying a subset of data from the historical production data associated with a shut-in period of days; and removing the subset of data associated with the shut-in period of days from the historical production data. The decline model can have an elapsed days feature variable that is reset by an occurrence of an acid job or a recompletion at the target well. The input data set can be generated from an initial data set filtered based on a well age or a type of well. The first time interval or the second time interval can be based on a user input indicating a desired length of time, or a comparison of different lengths of time affecting an absolute percentage error of the predicted well production profile. Additionally, the method can further comprise developing the target well based on the predicted well production profile. Moreover, in some instances, a system is adapted to carry out the method(s) discussed herein, the system comprising: a predictive decline modeling system including the static model trained using the historical production data and the decline model trained using the historical production data and the dynamic well data, the predictive decline modeling system receiving the one or more well features of the target well and the first time interval and generating the predicted well production profile.

Other implementations are also described and recited herein. Further, while multiple implementations are disclosed, still other implementations of the presently disclosed technology will become apparent to those skilled in the art from the following detailed description, which shows and describes illustrative implementations of the presently disclosed technology. As will be realized, the presently disclosed technology is capable of modifications in various aspects, all without departing from the spirit and scope of the presently disclosed technology. Accordingly, the drawings and detailed description are to be regarded as illustrative in nature and not limiting.

### BRIEF DESCRIPTION OF THE DRAWINGS

The foregoing summary, as well as the following detailed description, will be better understood when read in conjunction with the appended drawings. For the purpose of illustration, there is shown in the drawings certain embodiments of the disclosed subject matter. It should be understood, however, that the disclosed subject matter is not limited to the precise embodiments and features shown. The accompanying drawings, which are incorporated in and constitute a part of this specification, illustrate implementations of systems, methods, and apparatuses consistent with the disclosed subject matter and, together with the description, serve to explain advantages and principles consistent with the disclosed subject matter, in which:

FIG. 1 shows an example network environment that may implement various systems and methods discussed herein;

FIG. 2 is a block diagram illustrating an example data flow for generating a well production profile utilizing deep learning and/or computer pattern recognition techniques for predictive decline modeling that may form at least a portion of any of the systems or methods discussed herein;

FIG. 3 illustrates an example predictive decline modeling system for generating a well production profile that may form at least a portion of any of the systems or methods discussed herein;

FIG. 4 illustrates an example static model that may form at least a portion of any of the systems or methods discussed herein;

FIG. 5 illustrates an example decline model that may form at least a portion of any of the systems or methods discussed herein;

FIG. 6 illustrates an example block diagram of a resource production rate modeling tool for predictive decline modeling that may form at least a portion of any of the systems or methods discussed herein;

FIG. 7 illustrates example operations for generating the well production profile that may be performed by any of the systems discussed herein;

FIG. 8 illustrates example operations for generating the well production profile that may be performed by any of the systems discussed herein; and

FIG. 9 illustrates an example computing system that may implement any of the systems and methods discussed herein.

### DETAILED DESCRIPTION

Aspects of the present disclosure involve systems and methods for modeling resource production rates (e.g., oil production rates and/or natural gas production rates) for wells. In one aspect, a resource production rate modeling system includes a predictive decline modeling (PDM) tool that generates a well production profile for a given or selected target well. The well production profile indicates how the predicted resource production rate for the target well will change over time (e.g., plotted on an x-y graph), and can extend into the future to predict the decline in resource production rate with an assumed drawdown profile and ultimately becomes inactive.

In some examples, the predictive decline modeling system may generate a static model with supervised machine learning and a decline model with a neural network. The production decline model may receive the same input data of historical production data as the static model, and other dynamic data, to predict how the resource production rate for the target well will decline for a given time interval. Multiple recursive calculations are performed to calculate multiple final resource production rates for multiple time intervals which, when aggregated with the initial resource production rate calculated by the static model, form the well prediction profile.

In some examples, the predictive decline modeling system may generate the well production profile based on analyzing the input data set and the dynamic data without reliance on physics-based formulas. For instance, the predictive decline modeling system may train and validate the static model and the decline model with the input data set of historical production data. Pattern recognition algorithms of the recursive machine learning model and the neural network identify patterns and correlations in the input data set and dynamic data corresponding to resource production to replace any utilization of physics-based formulas. Because physics-based formulas may include complex, computationally expensive calculations (even in a simplified form) and may still fail to capture the underlying physical structure of the reservoir, the systems disclosed herein may generate a more accurate well production profile in a more efficient manner (e.g., using less computational resources and less time) than typical approaches. The systems disclosed herein may have a reduced mean absolute percentage error (MAPE) value compared to typical approaches for predictions of both the initial resource production rate and the resource production decline. Furthermore, the error rates of the predictive decline modeling system may be stable throughout the time intervals, further improving upon typical approaches (which can have a growing error rate as the prediction extends further in time). Moreover, the systems disclosed herein may be used to determine an effect of drawdown procedures on production or a drawdown optimization by simulating drawdown scenarios with simulated drawdown parameters as feature inputs to the predicted decline model. As such, the systems disclosed herein can predict how the drawdown scenarios will impact the target well's production rate. Similarly, the predictive decline modeling system can predict the performance of an acid job on the target well. Additional advantages of the disclosed technology may become apparent from the disclosure herein.

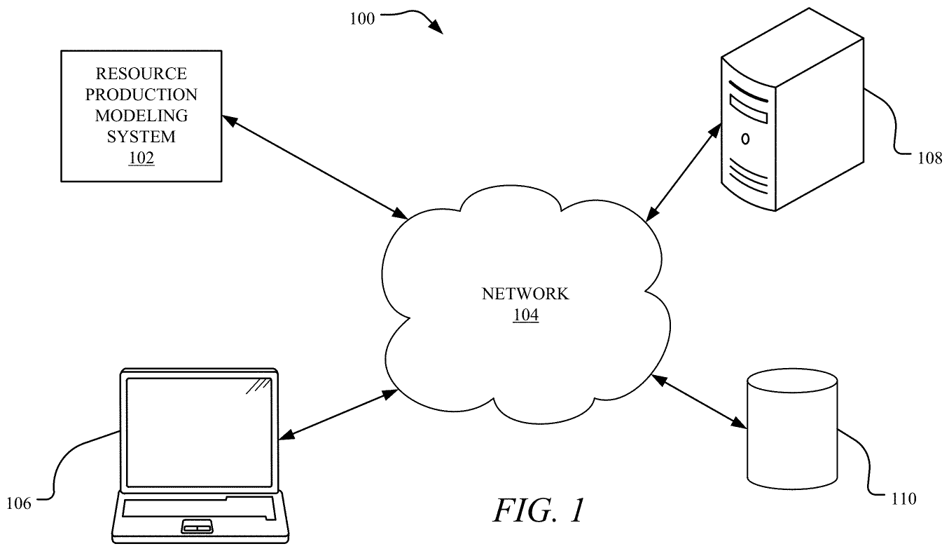

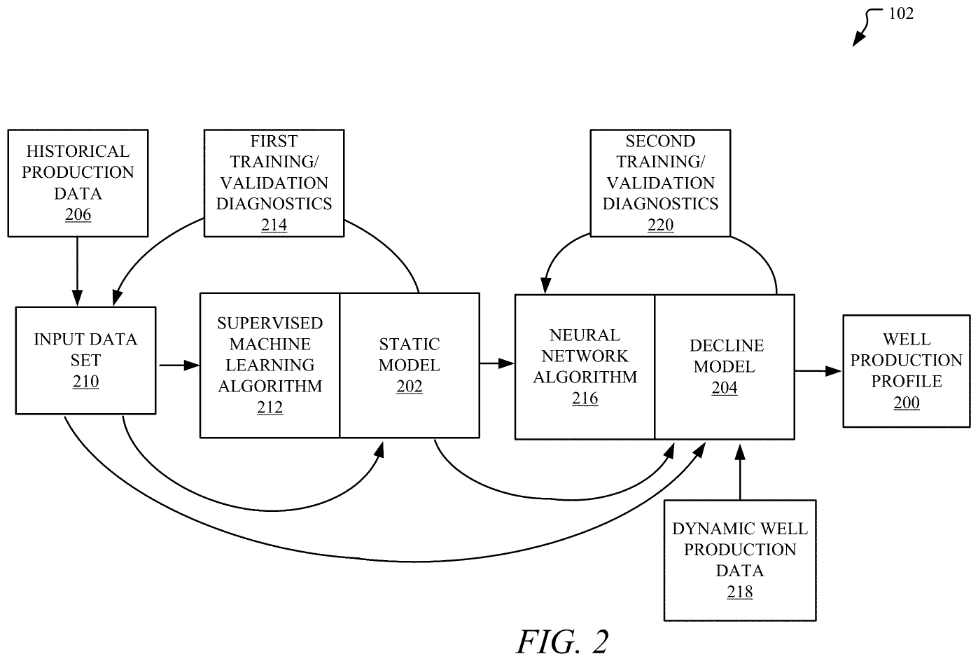

To begin a detailed discussion of an example system for modeling production decline for a well extracting a resource (e.g., oil and/or natural gas), reference is made to FIG. 1. FIG. 1 illustrates an example network environment 100 for implementing the various systems and methods, as described herein including a resource production rate modeling system 102. As depicted in FIG. 1, a network 104 is used by one or more computing or data storage devices for implementing a resource production rate modeling system 102 to generate one or more resource production models (e.g., static model 202 and decline model 204 illustrated in FIG. 2, etc.). In one implementation, various components of the resource production rate modeling system 102, one or more user devices 106, one or more databases 110, and/or other network components or computing devices described herein are communicatively connected to the network 104. Examples of the user devices 106 include a terminal, personal computer, a smart-phone, a tablet, a mobile computer, a workstation, and/or the like.

A server 108 may, in some instances, host the system. In one implementation, the server 108 also hosts a website or an application that users may visit to access the network environment 100, including the resource production rate modeling system 102. The server 108 may be one single server, a plurality of servers with each such server being a physical server or a virtual machine, or a collection of both physical servers and virtual machines. In another implementation, a cloud hosts one or more components of the system. The resource production rate modeling system 102, the user devices 106, the server 108, and other resources connected to the network 104 may access one or more additional servers for access to one or more websites, applications, web services interfaces, etc. that are used for production decline modeling and/or generating a well production profile.

FIG. 2 is a block diagram illustrating an example data flow for the resource production rate modeling system 102 to generate a well production profile 200 utilizing supervised machine learning to generate a static model 202 and a neural network to generate a decline model 204. Through the data flow of FIG. 2, the static model 202, the decline model 204, and the well production profile 200 may be generated without the need to utilize any physics laws or physics-based modeling. Rather, artificial intelligence such as supervised machine learning, neural networks, and other algorithms or techniques may be trained through one or more iterative and validation process using historical production data 206 and dynamic well data (e.g., dynamic well production data 218) to calculate a plurality of final resource production rates for a plurality of time intervals that, when aggregated, generate the well production profile 200. In one particular implementation, the steps outlined in the data flow of FIG. 2 may be executed by the resource production rate modeling system 102 automatically or in response to inputs provided through a user interface to generate the well production profile 200. In other instances, however, any component of the network environment 100 may execute one or more applications as described in relation to the data flow of FIG. 2.

In some examples, the data flow may include generating an input data set 210 as input to a supervised machine learning algorithm, technique, or system (e.g., supervised machine learning algorithm 212). The input data set 210 may include the historical production data 206 and/or any well production related data, such as but not limited to data representing geological features at well locations, drilling or completion data for the wells, properties of subterranean reservoirs at locations of the wells, production data of the wells, injection data from the water injection wells surrounding the target wells, or fluid data for the wells.

In some examples, geological feature dat —the data representing geological features at the well locations—may include one or more different types of data such as formation data, permeability data, porosity data (e.g., effective porosity data), clay content data, effective oil saturation (SOE), depth and thickness data (measured depth (MD), true vertical depth (TVD), total thickness, net-to-gross ratio (NTG)), completed thickness, or completed thickness with interval thicker than 2 meters. The drilling or completion data may include data related to top hole perforations or bottom hole perforations, a completion hole size, a completion job code, a screen size (e.g., sand screen size), a perforation measured depth (MD) or true vertical depth (TVD), a perforation clustering, a fracture gradient (e.g., in pounds-per-square inch (psi) per foot), a proppant type or amount, a slurry volume, or any combinations thereof (e.g., such that improve the accuracy of the static model 202). The production data may include one or more different types of data such as a daily oil production volume, a gas production volume, a water production volume, a ESP pump intake pressure, a drawdown pressure, a wellhead pressure (WHP), a oil gravity, a flow line temperature, a flow line pressure, and a ESP pump intake temperature, a well test (e.g., daily production data of the well test). The injection data may include an injection daily volume, an injection volume target, a well head pressure, a choke size, a pre-valve pressure, a well head temperature, a casing pressure, a cumulative injection volume, or combinations thereof (e.g., such that improve the accuracy of the static model 202.

In some instances, the input data set 210 may be a filtered subset of a larger dataset. For instance, an initial dataset may be filtered based on one or more well features or well metrics of the target well so that the filtered input data set 210 includes data more relevant to the target well than the larger, unfiltered data set. For instance, the larger dataset may be filtered based on a type of the target well (e.g., oil, gas, oil and gas, producer, etc.), and/or a date or age of the target well (e.g., all wells since 2011, all wells since 2012, etc.). As such, the input dataset 210 provided to the static model 202 for calculating initial production values for the well production profile 200 may be based on one or more features of the target well. The input data set 210 may include historical production data 206 related to a plurality of wells distributed throughout multiple reservoir sites (e.g., training wells). The historical production data 206 may relate to wells at various stages of surveying, drilling, encasing, completion, injection, and production. In some instances, the historical production data 206 may be generated from various sources that have partial or incomplete data, but may be aggregated according to a training well identifier or reservoir site identifier of the training well to generate the historical production data 206. In some instances, the input data set 210 may be continually updated as updated information is received from active wells of the training wells.

In some examples, the supervised machine learning system 212 may determine that any particular one of the different types of geological feature data, the drilling or completion data, the production data, the injection data, or the fluid data disclosed above may have a greater causal correlation with a resource production rate achieving the target variable resource production rate, e.g., (IP30, IP60, IP 60, IP 180, etc.) and, as such, the particular type of data may be assigned a greater weight than other types of data by the supervised machine learning system 212. For instance, the supervised machine learning system 212 may utilize aspects of pattern recognition techniques to generate the static model 202 from the input data set 212 by recognizing correlations between data trends and combinations of data trends of particular data types and resource production rates.

In some examples, a first training/validation diagnostics technique, algorithm, or system (e.g., first training/validation diagnostics 214) may be performed on the static model 202 to refine the static model 202 and improve its accuracy. For instance, the supervised machine learning system 212 may use a training data set representing information for between 100 and 200 training wells (e.g., that have previously been completed and produced oil and/or natural gas). The first training/validation diagnostics 214 may use between 10 and 50 wells from the historical data set 206 as a holdout data set (e.g., a validation data set). Data corresponding to wells in the holdout data set is compared to results generated by the static model 202 (e.g., after the static model 202 is trained with the training data set) to determine how closely the static model 202 can predict initial oil production rates for wells in the holdout data set (e.g., based on the geological feature data, and the completion data).

For instance, the first training/validation diagnostics 214 may iteratively train multiple static models 202, based on the input data set 210, to determine a combination of correlations between the geological feature data, the drilling or completion data, the production data, the injection data, the development data, and/or the fluid data as they relate to an initial resource production rate. For example, the first training/validation diagnostics 214 may utilize one or more pattern recognition algorithms to correlate the resource production rate with various generated static models 202 and, through a regression algorithm, may train/validate the various generated models with the input data set 210. In one implementation, the first training/validation diagnostics 214 may be applied to each generated static model 202 to determine an accuracy of the static model when applied to training wells from the input data set 210. Through a determined error obtained from the application of the various static models 202 to the input data set 210, the supervised machine learning algorithm 212 may determine how accurate or how closely the generated static model 202 corresponds to the input data set 210. The first training/diagnostics 214 of the supervised machine learning algorithm 212 may then alter the generated static model 202 based on the determined error to address and attempt to eliminate the error. This process of model generation, regression, validation, and alteration may be repeated until the determined error of the static model 202 (as based on the first training/validation diagnostics 214) falls below a threshold value. In this manner, the supervised machine learning algorithm 212 may utilize techniques (such as one or more pattern recognition algorithms) to generate or alter static models 202 that are trained, through the above-described iterative process, to accurately predict an initial resource production for a target well. Accuracy testing and modifying the static model 202 (e.g., adjusting variable weights) based on results of the validation testing with the holdout data set may further improve the accuracy of the static model 202.

In some examples, the static model 202 and the historical production data 206 may be provided to a neural network algorithm or system 216 to generate the decline model 204. The neural network system 216 may also receive and use dynamic well production data 218 (e.g., dynamic well operation data), in addition to the static model 202, to generate the decline model 204. For instance, the neural network system 216 may include two to seven dense layers having between 500 and 600 neurons per layer arranged to generate the decline model 204 with a target variable of oil at time (t) based on input features including the static model 202 (e.g., an initial resource production rate generated by the static model 202), and the dynamic well production data 218.

In some examples, the dynamic well production data 218 may include the initial resource production rate (e.g., generated by the static model 202 or provided by a user input), a resource production rate at a previous time interval, a bottom hole pressure of the target well at the current time interval, a shut-in bottom hole pressure of the target well at the current time interval, an average draw down pressure of the target well at the current time interval, and/or combinations thereof. With the initial resource production rate (e.g., generated by the static model 202) and the dynamic well production data 218 as feature inputs, the decline model 204 may output a resource production rate for a particular time interval. Multiple recursive calculations may be performed by the decline model 204 for multiple time intervals, wherein a predicted resource production rate for a time interval is used as an input resource production rate for a subsequent time interval, and so on for any number of time intervals. The plurality of the predicted resource production rates for the plurality of time intervals (e.g., which may be presented on an x-y graph having time on an x-axis and resource production rate on a y-axis) may constitute the well production profile 200. In other words, the well production profile 200 may be generated as a series of subsequent resource output rates for a plurality of time intervals generated by the decline model 204 and using the static model 202 to generate the initial resource production rate.

In some examples, the neural network system 216 may generate the decline model 204 using second training//validation diagnostics 220. For instance, the neural network system 216 may use between 15,000 and 20,000 rows of data related to the training wells and/or resource production at the training wells as a training data set for generating the decline model 204. Between about 1,000 and 2,000 rows of data from the training data set may be used as a holdout data set for the validation process. For instance, the second training/validation diagnostics 220 may iteratively train multiple decline models 204, based on the feature inputs, to determine multiple well production profiles for wells represented by the holdout data set. The multiple well production profiles may be compared to the holdout data set to determine errors for the multiple well production profiles. A process of model generation, regression, validation, and alteration may be repeated until the error of the decline model 204 falls below a threshold value (e.g., similar to the process discussed above regarding the first validation/diagnostics 214). For instance, the resource production rate modeling system 102 can optimize the model as part of an optimization loop. The optimization loop can optimize the model based on the accuracy of the model using the validation dataset, and assess a final performance of a best optimized model on the holdout set. In this manner, the neural network algorithm 216 may utilize techniques (such as one or more pattern recognition algorithms) to generate or alter decline models 204 that are trained, through the above-described iterative process, to accurately predict a final resource production of a target well for a time interval.

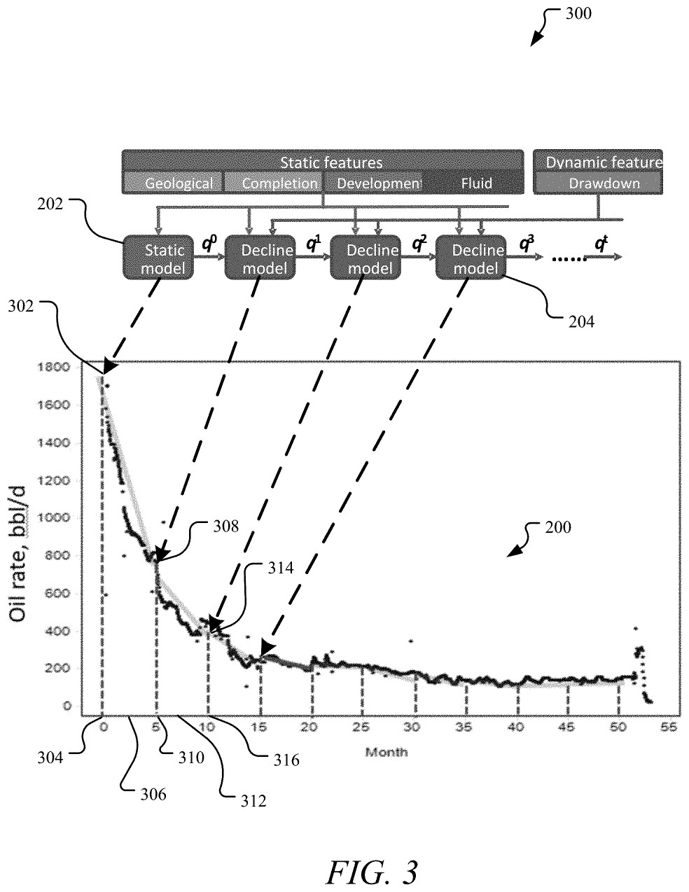

FIG. 3 illustrates an example predictive decline modeling system 300 for generating the well production profile 200, which may form a portion of any of the systems discussed herein (e.g., the resource production rate modeling system 102 of FIG. 1). FIG. 3 illustrates the well production profile 200 (red lines) layered over actual production data (e.g., black scatter plot) on an x-y graph representing time on the x-axis (e.g., in units of days, weeks, or months) and resource production rate (e.g. in units of barrels per day (bbl/day)) on the y-axis. In some instances, the production profile 200 may be based on multiple recursive calculations generated by the static model 202 and the decline model 204 indicating resource production rates at various time intervals. For instance, an initial resource production rate 302 may be calculated by the static model 202 at an initial time step 304 based on the input data set 210 (e.g., filtered based on one or more well features of the target well). The decline model 204 may calculate, based on the predicted initial resource production rate 302 and the dynamic well production data 218, a resource production rate 308 at the second timestep 310 after a time interval 306. The decline model 204 may calculate, using the predicted resource production rate 308 and other input data, a second resource production rate 314 at the next timestep 316. This process may be repeated any number of times for any number of time intervals using the predicted resource production rates at the previous time steps for subsequent timesteps.

In some examples, the predictive decline modeling system 300 may perform multiple recursive calculations to generate the predicted well production profile 200, for instance, by generating a plurality of resource production rates for a plurality of time intervals. The predictive decline modeling system 300 may calculate resource production rates for a series of time intervals. In some instances, the first time interval 306 and/or the second time interval 312 is between 10 days and six months (e.g., 15 days, one month, two months, three months, four months, five, months or six months). The first time interval 306 or the second time interval 312 may be determined based on a user input indicating a desired length of time. Additionally, or alternatively, the predictive decline modeling system 300 may generate multiple well production profiles 200 using time intervals of different lengths of time, and may compare the results of using different lengths of time to determine which length of time provides a most accurate well production profile 200 (e.g., by using the second training/validation diagnostics 220). The first time interval 306, the second time interval 312, and/or any number of time intervals may have a same length of time, or the length of time may vary based on a minimum accuracy threshold for each final resource production rate calculation and/or as needed based on available computational resource.

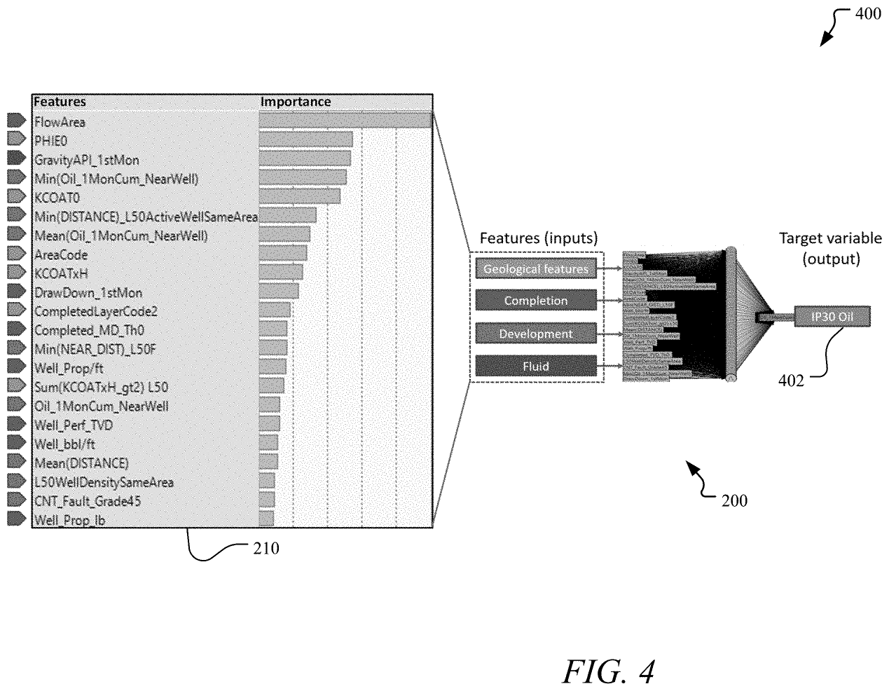

FIG. 4 illustrates an example system 400 for generating the static model 202, which may form at least a portion of any of the systems discussed herein. In some examples, the static model 202 may include a target variable 402 being a 30 days-averaged Initial Production rate (IP30). The input data set 210 may include a plurality of variables (e.g., from the historical production data 206) as feature inputs for the static model 202. In some instances, the feature inputs of the input data set 210 may be categorized into one or more data types, e.g., geological feature data, completion data, development data, and fluid data.

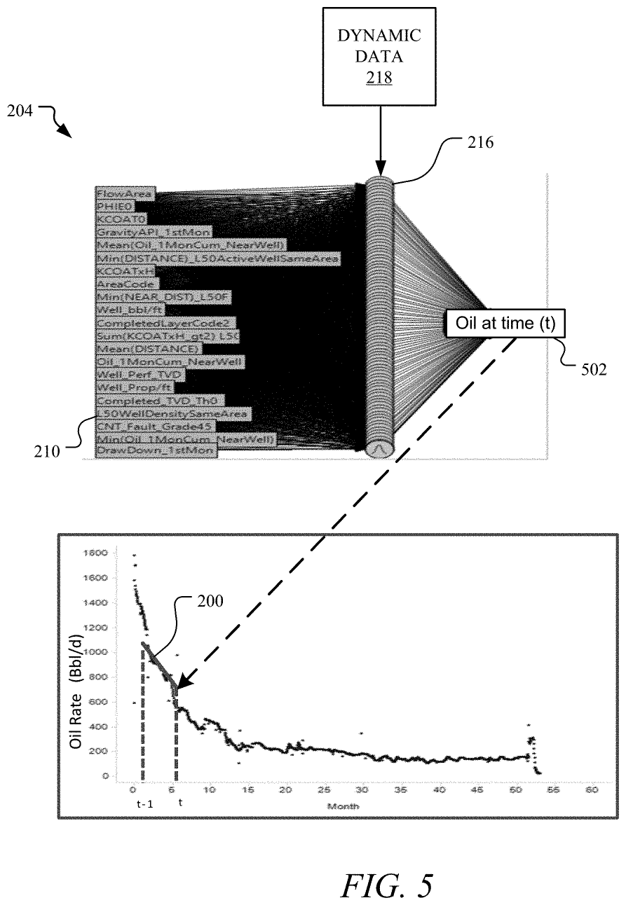

FIG. 5 illustrates an example system 500 including the decline model 204 for generating the well production profile 200 which may form at least a portion of any of the systems discussed herein. The neural network system 216 may generate the decline model 204 based on the historical production data 206 and/or the input data set 210 as feature inputs, and the dynamic well production data 218 as additional feature inputs. The dynamic well production data 218 may include mutable data that is updated recursively and/or may include data from different sources. For instance, the dynamic well production data 218 may include the initial resource production rate (e.g., generated by the static model 202 or provided by a user input), resource production rates at one or more previous time intervals (e.g., generated by the decline model 204), a bottom hole pressure of the target well at the current time interval, a shut-in bottom hole pressure of the target well at the current time interval, an average draw down pressure of the target well at the current time interval, and/or combinations thereof. With the initial resource production rate (e.g., generated by the static model 202) and the dynamic well production data 218 as feature inputs, the decline model 204 may output a resource production rate for a particular time step, and the process may be repeated multiple times for multiple time steps to generate the well production profile 200. In some instances, an elapsed days of production for the target well may be feature variable that is reset by an occurrence of an acid job or a recompletion at the target well.

In some examples, drawdown pressure data of the target well may be one of the feature variables considered by the decline model 204. The system 500 may determine that a particular time interval of the well production profile 200 being generated is missing a portion of the drawdown pressure data such that the drawdown pressure is incomplete and must be imputed to fully populate the data set. The missing drawdown pressure data may be imputed for the particular time interval. For instance, the missing drawdown pressure data may be imputed based on moving average pressure data for the target well and/or based on an average pressure from other wells within a same area code as the target well and/or at a same reservoir as the target well. In some examples, the system 500 may identify a subset of data of the historical production data 206 and/or the input data set to remove from consideration by the decline model 204. For instance, a period of days during which a shut-in event occurred at a particular one or more training wells may be identified, and data for the particular one or more training wells during the period of days may be removed from the historical production data 206 and/or the input data set 210.

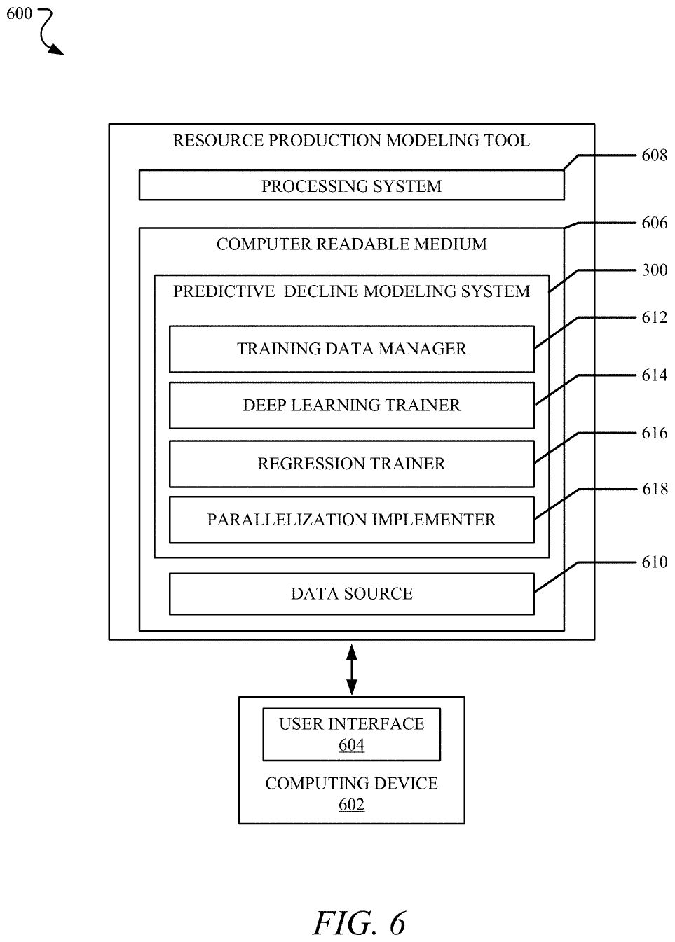

FIG. 6 shows an example block diagram of a resource production rate modeling tool 600 for generating the well production profile 200. In general, the resource production rate modeling tool 600 may include the predictive decline modeling system 300 and may form at least a part of the resource production rate modeling system 102 of FIG. 1. As shown in FIG. 6, the resource production rate modeling tool 600 may be in communication with a computing device 602 providing a user interface 604. As explained in more detail below, the resource production rate modeling tool 600 may be accessible to various users to generate the static model 202, the decline model 204, and the well production profile 200 based on the historical production data 206 and/or the input data set 210, which may be provided to the tool by the user. Access to the resource production rate modeling tool 600 may occur through the user interface 604 executed on the computing device 602.

As explained above, the resource production rate modeling tool 600 may generate the well production profile 200 based on the input data set 210. Thus, the resource production rate modeling tool 600 may include the predictive decline modeling system 300 executed to perform one or more of the operations described herein. The predictive decline modeling system 300 may be an application stored in a computer readable media 606 (e.g., memory) and executed on a processing system 608 of the resource production rate modeling tool 600 or other type of computing system, such as that described below. For example, the predictive decline modeling system 300 may include instructions that may be executed in an operating system environment, such as a Microsoft Windows™ operating system, a Linux operating system, or a UNIX operating system environment. The computer readable medium 606 includes volatile media, nonvolatile media, removable media, non-removable media, and/or another available medium. By way of example and not limitation, non-transitory computer readable medium 606 comprises computer storage media, such as non-transient storage memory, volatile media, nonvolatile media, removable media, and/or non-removable media implemented in a method or technology for storage of information, such as computer readable instructions, data structures, program modules, or other data.

The predictive decline modeling system 300 may also utilize a data source 610 of the computer readable media 606 for storage of data and information associated with the resource production rate modeling tool 600. For example, the predictive decline modeling system 300 may store information associated with iterations of the static model 202 and the decline model 204, training/validation diagnostic information or data, trained static models 202, trained decline models 204, model accuracy scoring, well production profiles 200, and the like. As described in more detail below, various generated models and profiles may be stored and used via the user interface 604 to simulate or otherwise determine well production profiles such that trained or optimized models and profiles for various target wells may be stored in the data source 610.

The predictive decline modeling system 300 may include several components to perform one or more of the operations described herein. For example, the predictive decline modeling system 300 may include a training data manager 612 to manage the input data set 210 for the supervised machine learning system 212 and/or the neural network 216 for generating one or more static models 202, decline models 204, and/or well production profiles 200 based on the input data set 210. The training data manager 612 may, in some instances, receive various types of data, such as well logs, well construction data, production data, seismic data, attribute data, and/or other types of well-related data and combine the data into the input data set 210 for use in generating the well production profile 200. Further, the training data manager 612 may also manage training/validation diagnostic information and data used in determining an accuracy of the well production profile 200 as compared to the input data set 210. For example, the training data manager 612 may compare simulated results of the decline model 204 and determine a difference between the simulated results and the input data set 210 to determine an accuracy of the generated model. Past results of the training of the model may also be stored and/or maintained by the training data manager 612 for comparison to current results to determine if the generated model is becoming more accurate or less accurate in response to operations performed by the supervised machine training system 212 and/or the neural network 216. In general, any information or data provided as inputs to the predictive decline modeling system 300 and/or utilized to train or validate the static model 202 or the decline model 204 may be managed by the training data manager 612.

The predictive decline modeling system 300 may also include a deep learning trainer 614 and regression trainer 616 to generate and/or train one or more static models 202 or decline models 204 based on the input data set 210 received from the training data manager 612. As explained above, the deep learning trainer 614 may include any machine learning or artificial intelligence techniques (e.g., the supervised machine learning system 212, the neural network 216, etc.) to generate the static model 202, the decline model 204, and the well production profile 200 from the input data set 210. In one particular implementation, the deep learning trainer 614 may employ a neural network to execute a pattern recognition algorithm on the input data set 210 and the dynamic well production data 218 to generate the decline model 204 and the well production profile 200. The regression trainer 616 may reduce the complexity of the generated models and profiles and apply the models to the first training/validation diagnostics 214 and 220 for iterative training. Together, the deep learning trainer 614 and the regression trainer 616 may develop a plurality of trained models of the resource production associated with the input data set 210.

A parallelization implementer 618 may also be included and executed by the predictive decline modeling system 300. In general, the parallelization implementer 618 may manage the parallelization of the training of the generated static models 202 and decline models 204 and/or model scoring with a high performance cluster (HPC). For instance, the overall data flow process described above with relation to FIG. 2 may be distributed across an HPC of computing devices. For example, the various trained models generated by the iterative process may be scored in parallel through a distribution of the trained models onto various computing machines of the HPC. In this manner, the simulations executed on the trained models and the accuracy scores of the various models may be obtained simultaneously to reduce the time needed to complete the model evaluations. In a similar manner, multiple computing devices may execute the deep learning/pattern recognition techniques in a parallel manner to generate the multiple trained models for the target well simultaneously such that the trained models may be generated at a faster rate than previous implementations that may generate the trained models serially. For example, the parallelization implementer 618 may provide the generated models to one or more computing devices of the HPC for training, simulation, and comparing to the diagnostic data. Similarly, the parallelization implementer 618 may communicate with one or more computing devices of the HPC to apply measured data to the trained models to determine an accuracy of the trained models. In general, any communication between the predictive decline modeling system 300 and the HPC may be managed by the parallelization implementer 618 to reduce the time to generate the static model 202, decline model 204, and/or the well production profile 200.

It should be appreciated that the components described herein are provided only as examples, and that the resource production rate modeling tool 600 may have different components, additional components, or fewer components than those described herein. For example, one or more components as described in FIG. 6 may be combined into a single component. As another example, certain components described herein may be encoded on, and executed on other computing systems.

Several advantages over previous ways to generating the well production profile 200 may be gained through the methods and systems described herein. For example, the resource production rate modeling system 102 may facilitate data loading, pre-processing, transformation and alignment to the well log data, a dynamic and flexible model construction process, and data handling, generation, augmentation during model training. Other advantages include automated techniques for model validation, automated capture of model training results, and automated implementation of model hyper-parameter optimization to repeatedly train new models in a search for the optimal model configuration. The described modeling framework also streamlines user access to Graphical Processing Unit (GPU) resources in the HPC to improve model training speed and a visualization and data framework allows users to track model optimization. The model prediction framework may also distribute the prediction tasks out to as many computational resources as desired in order to speed up the process while automatically taking care of the hardware resourcing, setup, and take-down tasks. Still other advantages include an efficient process that makes it easy for users to reduce interpretation bias common in previous reservoir model generation systems.

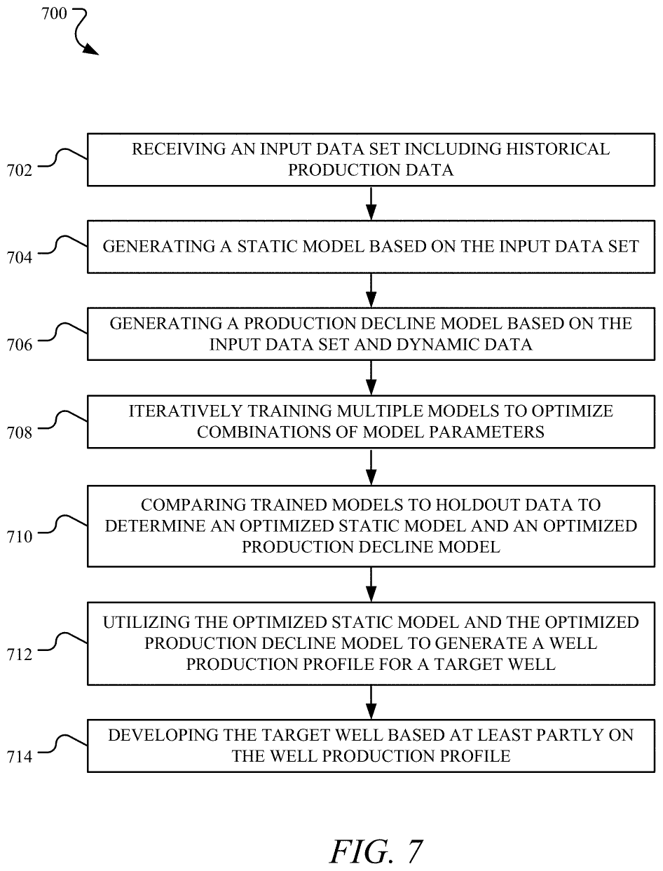

In particular, the predictive decline modeling system 300 may execute one or more of the operations illustrated in FIG. 7. In particular, FIG. 7 illustrates example operations of a method 700 for generating the well production profile 200, which may be performed by any of the systems discussed herein. The operations may be performed by a computing device configured to execute any machine learning or artificial intelligent algorithm, including image recognition techniques. Such operations may be executed through control of one or more hardware components, one or more software programs, or a combination of both hardware and software components of the computing device.

Beginning in operation 702, the computing device may receive the input data set 210 including any production or historical production data 206 for inclusion in modeling production decline for the target well. As explained above, such a dataset may include data obtained through well logs, production logs, seismic data, attribute data, or any other well modeling-related data.

In operation 704, the computing device may generate the static model 202 based on the input data set, for instance, by using the supervised machine learning system 212 and the first training/validation diagnostics 214 discussed in greater detail above.

In operation 706, the computing device may generate the decline model 204 based on the input data set 210 and the dynamic well production data 218, for instance, by using the neural network 216 and the second training/validation diagnostics 220 discussed in greater detail above.

In operation 708, the computing device may iteratively train multiple static models 202 and/or multiple decline models 204, based on the input data set 210 and the dynamic well production data 218, to determine a combination of correlations between the geological feature data, the drilling or completion data, the production data, the injection data, the development data, and the fluid data and a resource production rate. For example, the predictive decline modeling system 300 may utilize one or more pattern recognition algorithms to correlate the resource production rate with various generated static models 202 and, through a regression algorithm, may train/validate the various generated models with the input data set 210. In one implementation, the first training/validation diagnostics 214 may be applied to each generated static model 202 to determine an accuracy of the static model when applied to training wells from the input data set 210. Through a determined error obtained from the application of the various static models 202 to the input data set 210, the supervised machine learning algorithm 212 may determine how accurate or how closely the generated static model 202 corresponds to the input data set 210. The first training/diagnostics 214 of the supervised machine learning algorithm 212 may then alter the generated static model 202 based on the determined error to address and attempt to eliminate the error. This process of model generation, regression, validation, and alteration may be repeated until the determined error of the static model 202 (as based on the training/validation diagnostics 214) falls below a threshold value. In this manner, the supervised machine learning algorithm 212 may utilize techniques (such as one or more pattern recognition algorithms) to generate or alter static models 202 that are trained, through the above-described iterative process, to accurately predict an initial resource production for a target well.

In operation 710, the trained static models 202 and decline models 204 may be compared to holdout data to determine an optimized static model and an optimized decline model. For instance, the predictive decline modeling system 300 may generate models that each perform within the thresholds of the validation diagnostics. However, some models generated by the predictive decline modeling system 300 may be more accurate than others. To determine the optimal model generated by the system, each trained model may be applied to a parallel model scoring technique in operation 710. In particular, each trained model may be compared to data from one or more holdout wells of the holdout data set (e.g., discussed in greater detail above regarding FIG. 2) to determine an accuracy score for the generated trained models. To compare the trained models to the holdout well data, a simulation may be executed on each trained model to determine an expected dataset for the holdout wells and a comparison of the expected dataset to the actual datasets may be performed by the predictive decline modeling system 300. The trained model with the lowest delta between the expected dataset values and the measured dataset values at the holdout wells may be considered the optimized models (e.g., the optimized static model 202 or the optimized decline models 204). These optimized models may, in operation 712, be utilized to make predictions of the reservoir properties across the entire seismic volume for the reservoir being modeled.

In operation 712, the computing device may utilize the optimized static model 202 and the optimized decline model 204 to generate the well production profile 200 for the target well. For instance, the predictive decline modeling system 300 may calculate an initial resource production rate for the target well using the static model 202, and a plurality of final resource production rates for a plurality of time intervals using the optimized decline model 204.

In operation 714, the method 700 can include developing the target well based at least partly on the well production profile 200. For instance, the well production profile 200 may indicate that the target well is capable of producing a particular amount of resource (e.g., oil or gas) if the target well is developed and, in response, one or more well development actions may be taken for the target well, such as modifying a production process (e.g., increasing or decreasing an injection rate) and/or extraction of the hydrocarbons (e.g., the oil and/or the gas), etc. based on the predicted well production profile. In some instances, multiple well production profiles 200 may be generated to simulate different well development actions (e.g., by adjusting the dynamic well production data 218 to represent the well development actions) such that the system 100 may determine that particular well development action will result in an increased resource production for the target well. The particular well development action may be taken to develop the target well at least partly in response to the well production profile 200.

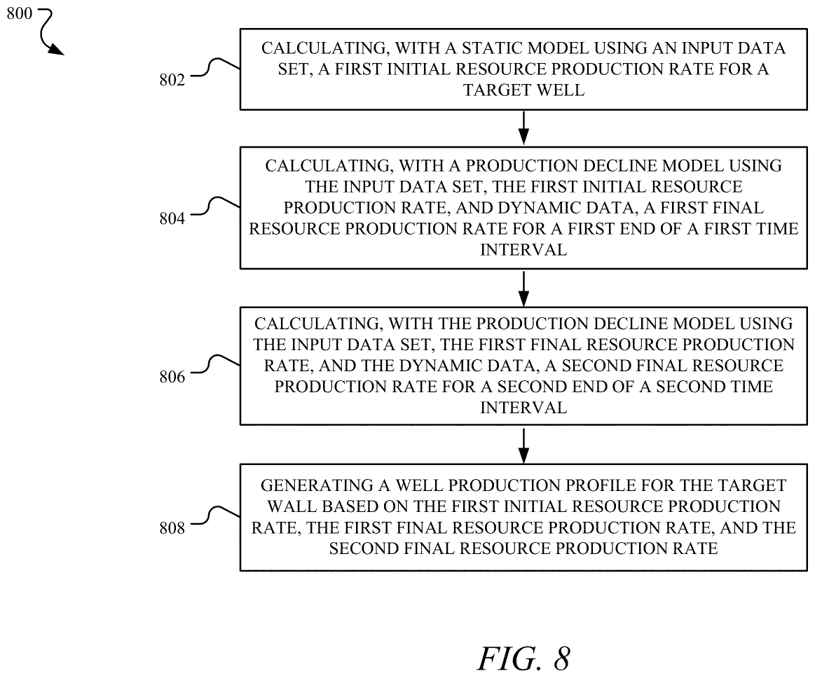

FIG. 8 illustrates an example method 800 for generating the well production profile 200 which may be performed by any of the systems discussed herein, such as the predictive decline modeling system 300. In operation 802, the predictive decline modeling system 300 may calculate, with the static model 202 (e.g., the trained and optimized static model 202) using the input data set 210, the initial resource production rate for the target well. In operation 804, the predictive decline modeling system 300 may calculate, with the decline model 204 using the input data set 210, the predicted initial resource production rate, and the dynamic well production data 218, a resource production rate for a first time interval. In operation 806, the predictive decline modeling system 300 may calculate, with the decline model 204 using the input data set 210, the first predicted resource production rate, and the dynamic well production data 218, a second predicted resource production rate for a second time interval. In operation 808, the predictive decline modeling system 300 may generate the well production profile 200 for the target well based on the predicted initial resource production rate, the recursively predicted resource production rates (e.g., the first predicted resource production rate and the second predicted resource production rate) at subsequent time intervals.

It is to be understood that the specific order or hierarchy of operations in the methods depicted in FIGS. 7 and 8 are instances of example approaches and can be rearranged while remaining within the disclosed subject matter. For instance, any of the operations depicted in FIGS. 7 and 8 may be omitted, repeated, performed in parallel, performed in a different order, and/or combined with any other of the operations depicted in FIGS. 7 and 8 or throughout this disclosure. For instance, operation 806 may be repeated any number of time (e.g., between three and 20 times or more than 20 times) to calculate any number of final resource production rates for any number of time intervals, which may be aggregated to form the well production profile 200 (e.g., at operation 808).

In some examples, the predictive decline modeling system 300 can generate the well production profile 200 based on analyzing the input data set 210 and without reliance on physics-based formulas. For instance, the decline modeling system 300 can identify patterns and correlations in the input data set 210 corresponding to resource production rates based on pattern recognition algorithms that are created by the supervised machine learning system 212 and the neural network 216 based exclusively on well, reservoir, and drilling-related data. In other words, the systems disclosed herein are data driven and pattern driven without necessarily attempting to map the subterranean reservoir or relying on fluid dynamic modeling of the oil and/or natural gas. Because physics-based formulas include complex, computationally expensive calculations (even in a simplified form) and may still fail to capture the underlying physical structure of the reservoir and well, the systems disclosed herein may generate the well production profile 200 in a more efficient manner using less computational resources and less than typical approaches. Moreover, the well production profile is more accurate than physics-based modeling systems. The systems disclosed herein may have a reduced mean absolute percentage error (MAPE) value as compared to typical approaches for both the initial resource production rate and the resource decline. The error rates of the predictive decline modeling system 300 may be stable throughout the time intervals, further improving upon typical approaches and allowing for drawdown period and acid job simulations.

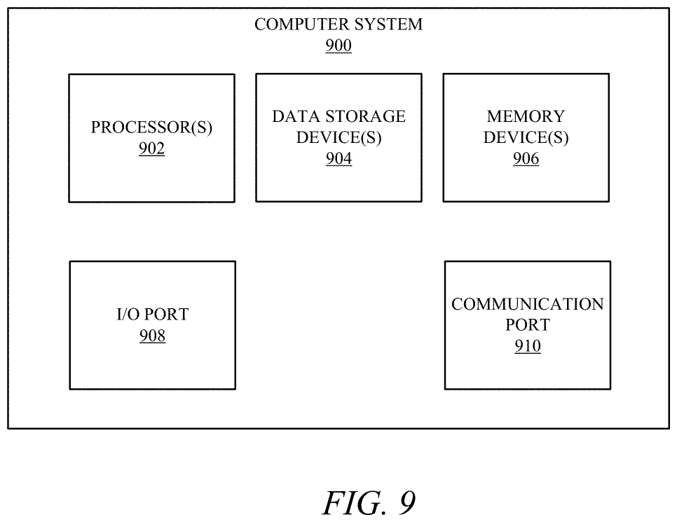

Referring to FIG. 9, a detailed description of an example computing system 900 having one or more computing units that may implement various systems and methods discussed herein is provided. The computing system 900 may be applicable to the resource production rate modeling system 102, the network environment 100, and other computing or network devices. It will be appreciated that specific implementations of these devices may be of differing possible specific computing architectures not all of which are specifically discussed herein but will be understood by those of ordinary skill in the art.

The computer system 900 may be a computing system is capable of executing a computer program product to execute a computer process. Data and program files may be input to the computer system 900, which reads the files and executes the programs therein. Some of the elements of the computer system 900 are shown in FIG. 9, including one or more hardware processors 902, one or more data storage devices 904, one or more memory devices 906, and/or one or more ports 908-910. Additionally, other elements that will be recognized by those skilled in the art may be included in the computing system 900 but are not explicitly depicted in FIG. 9 or discussed further herein. Various elements of the computer system 900 may communicate with one another by way of one or more communication buses, point-to-point communication paths, or other communication means not explicitly depicted in FIG. 9.

The processor 902 may include, for example, a central processing unit (CPU), a microprocessor, a microcontroller, a digital signal processor (DSP), and/or one or more internal levels of cache. There may be one or more processors 902, such that the processor 902 comprises a single central-processing unit, or a plurality of processing units capable of executing instructions and performing operations in parallel with each other, commonly referred to as a parallel processing environment.

The computer system 900 may be a conventional computer, a distributed computer, or any other type of computer, such as one or more external computers made available via a cloud computing architecture. The presently described technology is optionally implemented in software stored on the data stored device(s) 904, stored on the memory device(s) 906, and/or communicated via one or more of the ports 908-910, thereby transforming the computer system 900 in FIG. 9 to a special purpose machine for implementing the operations described herein. Examples of the computer system 900 include personal computers, terminals, workstations, mobile phones, tablets, laptops, personal computers, multimedia consoles, gaming consoles, set top boxes, and the like.

The one or more data storage devices 904 may include any non-volatile data storage device capable of storing data generated or employed within the computing system 900, such as computer executable instructions for performing a computer process, which may include instructions of both application programs and an operating system (OS) that manages the various components of the computing system 900. The data storage devices 904 may include, without limitation, magnetic disk drives, optical disk drives, solid state drives (SSDs), flash drives, and the like. The data storage devices 904 may include removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, SSDs, and the like. The one or more memory devices 906 may include volatile memory (e.g., dynamic random access memory (DRAM), static random access memory (SRAM), etc.) and/or non-volatile memory (e.g., read-only memory (ROM), flash memory, etc.).

Computer program products containing mechanisms to effectuate the systems and methods in accordance with the presently described technology may reside in the data storage devices 904 and/or the memory devices 906, which may be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures. The machine-readable media may store instructions that, when executed by the processor, cause the systems to perform the operations disclosed herein.

In some implementations, the computer system 900 includes one or more ports, such as an input/output (I/O) port 908 and a communication port 910, for communicating with other computing, network, or reservoir development devices. It will be appreciated that the ports 908-910 may be combined or separate and that more or fewer ports may be included in the computer system 900.

The I/O port 908 may be connected to an I/O device, or other device, by which information is input to or output from the computing system 900. Such I/O devices may include, without limitation, one or more input devices, output devices, and/or environment transducer devices.

In one implementation, the input devices convert a human-generated signal, such as, human voice, physical movement, physical touch or pressure, and/or the like, into electrical signals as input data into the computing system 900 via the I/O port 908. Similarly, the output devices may convert electrical signals received from computing system 900 via the I/O port 908 into signals that may be sensed as output by a human, such as sound, light, and/or touch. The input device may be an alphanumeric input device, including alphanumeric and other keys for communicating information and/or command selections to the processor 902 via the I/O port 908. The input device may be another type of user input device including, but not limited to: direction and selection control devices, such as a mouse, a trackball, cursor direction keys, a joystick, and/or a wheel; one or more sensors, such as a camera, a microphone, a positional sensor, an orientation sensor, a gravitational sensor, an inertial sensor, and/or an accelerometer; and/or a touch-sensitive display screen (“touchscreen”). The output devices may include, without limitation, a display, a touchscreen, a speaker, a tactile and/or haptic output device, and/or the like. In some implementations, the input device and the output device may be the same device, for example, in the case of a touchscreen.

In one implementation, a communication port 910 is connected to a network by way of which the computer system 900 may receive network data useful in executing the methods and systems set out herein as well as transmitting information and network configuration changes determined thereby. Stated differently, the communication port 910 connects the computer system 900 to one or more communication interface devices configured to transmit and/or receive information between the computing system 900 and other devices by way of one or more wired or wireless communication networks or connections. Examples of such networks or connections include, without limitation, Universal Serial Bus (USB), Ethernet, Wi-Fi, Bluetooth®, Near Field Communication (NFC), Long-Term Evolution (LTE), and so on. One or more such communication interface devices may be utilized via the communication port 910 to communicate one or more other machines, either directly over a point-to-point communication path, over a wide area network (WAN) (e.g., the Internet), over a local area network (LAN), over a cellular (e.g., third generation (3G) or fourth generation (4G) or fifth generation (5G) network), or over another communication means. Further, the communication port 910 may communicate with an antenna or other link for electromagnetic signal transmission and/or reception.

In an example implementation, historical production data 206, dynamic well production data 218, and software and other modules and services may be embodied by instructions stored on the data storage devices 904 and/or the memory devices 906 and executed by the processor 902. The computer system 900 may be integrated with or otherwise form part of the air filtration system resource production rate modeling tool 600.

The system set forth in FIG. 9 is but one possible example of a computer system that may employ or be configured in accordance with aspects of the present disclosure. It will be appreciated that other non-transitory tangible computer-readable storage media storing computer-executable instructions for implementing the presently disclosed technology on a computing system may be utilized.

In the present disclosure, the methods disclosed may be implemented as sets of instructions or software readable by a device. Further, it is understood that the specific order or hierarchy of steps in the methods disclosed are instances of example approaches. The accompanying method claims present elements of the various steps in a sample order, and are not necessarily meant to be limited to the specific order or hierarchy presented.

The described disclosure may be provided as a computer program product, or software, that may include a non-transitory machine-readable medium having stored thereon instructions, which may be used to program a computer system (or other electronic devices) to perform a process according to the present disclosure. A machine-readable medium includes any mechanism for storing information in a form (e.g., software, processing application) readable by a machine (e.g., a computer). The machine-readable medium may include, but is not limited to, magnetic storage medium, optical storage medium; magneto-optical storage medium, read only memory (ROM); random access memory (RAM); erasable programmable memory (e.g., EPROM and EEPROM); flash memory; or other types of medium suitable for storing electronic instructions.

While the present disclosure has been described with reference to various implementations, it will be understood that these implementations are illustrative and that the scope of the present disclosure is not limited to them. Many variations, modifications, additions, and improvements are possible. More generally, embodiments in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. A method for predictive decline modeling for an oil well, the method comprising:
generating a static model based on an input data set including historical production data corresponding to one or more wells;
generating a decline model based on the historical production data and dynamic well data; and
generating a predicted well production profile for a target well by:
determining, using the static model and one or more well features of the target well, a predicted initial resource production rate for the target well;
determining, using the decline model and the predicted initial resource production rate, a first final resource production rate for the target well at a first time interval; and
determining, using the decline model and the first final resource production rate at the first time interval, a second final resource production rate at a second time interval subsequent to the first time interval.

2. The method of claim 1, wherein generating the predicted well production profile includes recursive calculations generating resource production rates for a series of time intervals.

3. The method of claim 1, wherein the static model is generated with supervised machine learning using the historical production data as feature inputs and a target variable being an initial resource production rate having a 30 days-averaged Initial Production (IP30) value.

4. The method of claim 1, wherein the historical production data represents one or more of a geological feature, well completion parameters, reservoir properties, production data, injection data, and fluid data.

5. The method of claim 1, wherein the decline model is generated with a neural network using the historical production data and the dynamic well data as feature inputs and a target variable being resource production rate at time (t).

6. The method of claim 5, wherein the neural network includes two to seven dense layers and between 100 and 600 neurons per layer.

7. The method of claim 1, wherein the dynamic well data includes one or more of a resource production rate for a previous time interval, a bottom hole pressure at the target well, a shut-in bottom hole pressure at the target well, and an average draw down pressure at the target well.

8. The method of claim 1, further comprising:
identifying a subset of data from the historical production data associated with a shut-in period of days; and
removing the subset of data associated with the shut-in period of days from the historical production data.

9. The method of claim 1, wherein the decline model has an elapsed days feature variable that is reset by an occurrence of an acid job or a recompletion at the target well.

10. The method of claim 1, wherein the input data set is generated from an initial data set filtered based on a well age or a type of well.

11. The method of claim 1, wherein the first time interval or the second time interval is based on a user input indicating a desired length of time, or a comparison of different lengths of time affecting an absolute percentage error of the predicted well production profile.

12. The method of claim 1, further comprising developing the target well based on the predicted well production profile.

13. One or more tangible non-transitory computer-readable storage media storing computer-executable instructions for performing a computer process on a computing system, the computer process comprising:
generating a static model based on an input data set including historical production data corresponding to one or more wells;
generating a decline model based on the historical production data and dynamic well data; and
generating a predicted well production profile for a target well by:
calculating, using the static model and one or more well features of the target well, a predicted initial resource production rate for the target well;
calculating, using the decline model and the predicted initial resource production rate, a first final resource production rate for the target well at a first time interval; and
calculating, using the decline model and the first final resource production rate at the first time interval, a second final resource production rate at a second time interval subsequent to the first time interval.

14. The one or more tangible non-transitory computer-readable storage media of claim 13, wherein generating the predicted well production profile includes recursive calculations generating resource production rates for a series of time intervals.

15. The one or more tangible non-transitory computer-readable storage media of claim 13, wherein the static model is generated with supervised machine learning using the historical production data as feature inputs and a target variable being an initial resource production rate having a 30 days-averaged Initial Production (IP30) value.

16. The one or more tangible non-transitory computer-readable storage media of claim 13, wherein the decline model is generated with a neural network using the historical production data and the dynamic well data as feature inputs and a target variable being resource production rate at time (t).

17. The one or more tangible non-transitory computer-readable storage media of claim 13, the computer process further comprising:
identifying a subset of data from the historical production data associated with a shut-in period of days; and
removing the subset of data associated with the shut-in period of days from the historical production data.

18. The one or more tangible non-transitory computer-readable storage media of claim 13, wherein the input data set is generated from an initial data set filtered based on a well age or a type of well.

19. A system for predictive decline modeling for an oil well, the system comprising:
a predictive decline modeling system configured to generate a predicted well production profile for a target well, the predicted well production profile generated by determining a predicted initial resource production rate for the target well, a first final resource production rate for the target well at a first time interval, and a second final resource production rate at a second time interval subsequent to the first time interval, the predicted initial resource production rate determined using a static model and one or more well features of the target well, the first final resource production rate determined using a decline model and the predicted initial resource production rate, the second final resource production rate determined using the decline model and the first final resource production rate at the first time interval.

20. The system of claim 19, wherein the static model is generated based on an input data set including historical production data corresponding to one or more wells and the decline model is generated based on the historical production data and dynamic well data.
